(19) United States
(12) Patent Application Publication
(10) Pub. No.: US 2016/0253708 A1
(43) Pub. Date: Sep. 1, 2016

(54) METHOD AND SYSTEM FOR EFFICIENTLY SERVING UPSELL CONTENT BASED ON COMPLEX USER ARCHETYPES

(71) Applicant: Dropbox, Inc., San Francisco, CA (US)

(72) Inventors: Viraj Mody, San Francisco, CA (US); Robert Kajic, San Francisco, CA (US); Pranav Piyush, San Francisco, CA (US); Lilian Weng, San Francisco, CA (US)

(21) Appl. No.: 14/632,289

(22) Filed: Feb. 26, 2015

(51) Int. Cl. G06Q 30/02

(52) U.S. Cl. CPC G06Q 30/0269

(57) ABSTRACT

Techniques for efficiently selecting upsell content to serve to users of an online service based on complex user archetypes. Serving upsell content to a user may include selecting upsell content to serve to the user based on efficiently matching the user to a complex user archetype in response to receiving a request from a computing device of the user. The user archetype may be complex in the sense that it represents a specific pattern of user interaction with the online service over a period of time, as opposed to being based solely on user demographic information such as the users' age, sex, gender, ethnicity, location of residence, profession, and the like. In addition, the specific pattern may vary depending on the type of online service. For example, according to some of the disclosed embodiments, upsell content may be efficiently selected to serve to a user of a content item management service based on the user having added five or more work files to the content item management service or edited one or more work files hosted with the content item management service during the last twenty-eight days.

### TECHNICAL FIELD

The disclosed embodiments relate generally to online services such as web sites, and more specifically to efficiently serving upsell content to users of online services based on complex user archetypes.

### BACKGROUND

Many online service providers (e.g., web site operators) wish to promote to a user a feature of their service other than the feature the user is currently using. For example, an online service provider may want to promote a new feature of the service while the user is using a regularly used feature. Such promotions, when presented to a user in a computer graphical user interface, may be referred to as “upsell content” as the promotions typically have the goal of persuading the user to use the service in a way that increases the user's level of engagement with the service. Upsell content is often presented in the graphical user interface with primary application content provided by the service. For example, if the user is currently using only a “free” feature of the service that has limited functionality, then upsell content presented to the user on the “home” web page of the online service may promote a subscription fee-based feature of the service that provides enhanced functionality to the user.

When a user requests primary application content from an online service (e.g., by using a web browser application), the online service may select upsell content to serve to the user in addition to serving the requested primary application content. One way for the online service to select the upsell content to serve is to simply serve the same upsell content to all users. However, online service providers may wish to target different users with different upsell content in very specific ways that are designed to maximize the probability that the users will increase their level of engagement with the online service.

Overall, online service providers would appreciate techniques that enable them to efficiently select upsell content to serve to users of the online service and that facilitates targeting the users with upsell content in very specific ways.

### SUMMARY OF SOME DISCLOSED EMBODIMENTS

Techniques for efficiently selecting upsell content to serve to users of an online service based on complex user archetypes are provided by some disclosed embodiments. In some of the disclosed embodiments, serving upsell content to a user includes selecting upsell content to serve to the user based on efficiently matching the user to a complex user archetype in response to receiving a request from a computing device of the user. The user archetype may be complex in the sense that it represents a specific pattern of user interaction with the online service over a period of time, as opposed to being based solely on user demographic information such as the users' age, sex, gender, ethnicity, location of residence, profession, and the like. In addition, the specific pattern may vary depending on the type of online service. For example, according to some of the disclosed embodiments, upsell content may be efficiently selected to serve to a user of a content item management service based on the user having added five or more work files to the content item management service or edited one or more work files hosted with the content item management service during the last twenty-eight days.

In accordance with some embodiments, a computer-implemented method for efficiently serving upsell content to a user of an online service based on complex user archetypes executes at one or more server computers of the online service. The server computers collectively have one or more processors and memory. The memory stores one or more programs for execution by the one or more processors. The method determines, for each of a plurality of predefined complex user archetypes, whether a user is or is not the predefined complex user archetype, based on user events reflecting the user's interaction with primary application content of the online service over a period of time. The method stores a set of a plurality of user upsell attributes for the user in a database. Each of the plurality of user upsell attributes corresponds to one of the plurality of predefined complex user archetypes and has a value that indicates whether the user is or is not the corresponding predefined complex user archetype. In response to receiving a request from a computing device used by user, the method (a) identifies one or more upsell campaigns associated with particular primary application content of the online service. Each of the one or more upsell campaigns is associated with upsell content and is also associated with a set of one or more user archetype rules. In response to the receiving the request, the method also (b) determines whether the set of one or more user archetype rules associated with an upsell campaign of the one or more upsell campaigns is satisfied by the set of user upsell attributes for the user. Also in response to receiving the request, the method (c) serves the upsell content associated with the upsell campaign to the computing device used by user, if the set of one or more user archetype rules associated with the upsell campaign is satisfied by the set of user upsell attributes for the user.

Thus methods and systems are provided that make selection of upsell content to serve to a user based on complex user archetypes faster, and enable more efficient use of computing and network resources. Faster selection results in serving upsell content to users more quickly. More efficient usage of computing and network resources leaves more of those resources for other tasks, making the other tasks complete faster.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a schematic diagram of a system environment in which some embodiments of the present invention may be implemented.

FIG. 2 depicts an example of upsell content displayed in a graphical user interface in conjunction with primary application content of an online service, according to some embodiments of the present invention.

FIG. 3A and FIG. 3B are a flowchart of a process for efficiently serving upsell content based on complex user archetypes, according to some embodiments of the present invention.

FIG. 4 is a block diagram that illustrates an example computing device 400 suitable for implementing some embodiments of the present invention.

FIG. 5 is a block diagram of a software system that may be employed for controlling the operation of the example computing device 400 of FIG. 4, according to some embodiments of the present invention.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

### DETAILED DESCRIPTION OF EMBODIMENTS

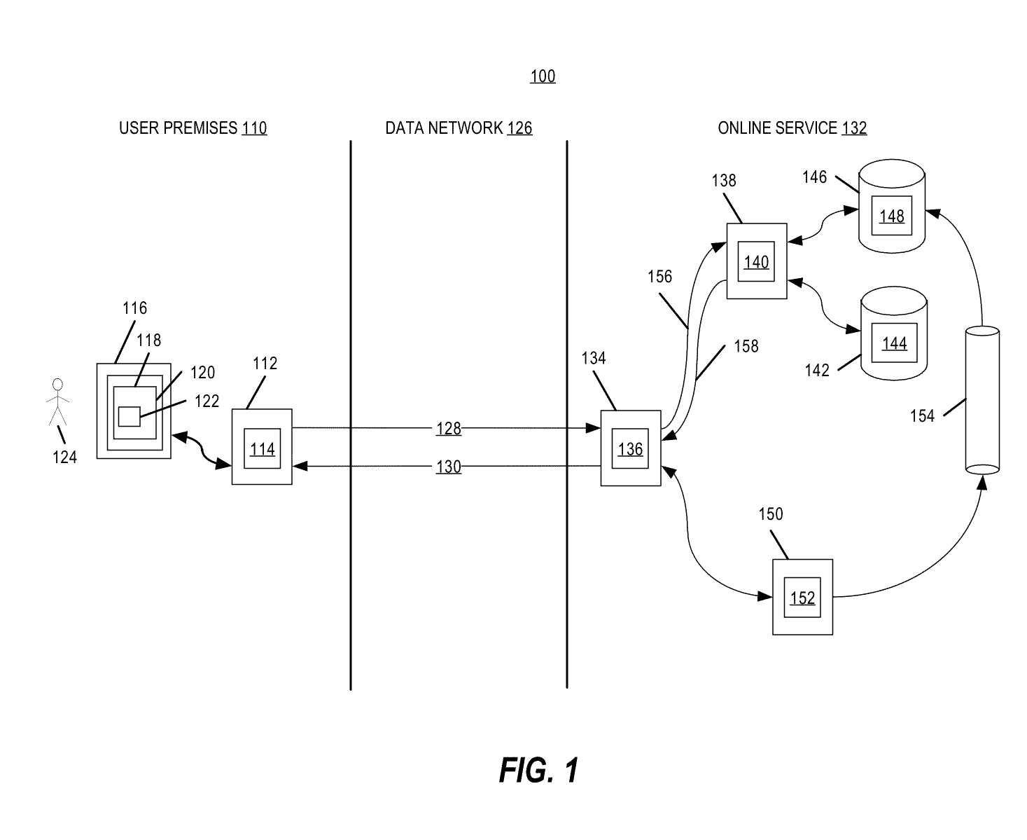

Turning first to FIG. 1, it is a schematic diagram of a system environment 100 in which some embodiments of the present invention for serving upsell content to a user of an online service based on complex user archetypes may be implemented. Environment 100 includes user premises 110, data network 126, and online service 132.

In some examples presented herein, online service 132 is assumed to be a content item management system that allows users to store their personal content items (e.g., documents, files, and photos) on servers of operated and managed by the content item management system. In addition to storing content items on content item management system servers, the content item management system may enable users to perform related tasks such as sharing content items with other users of the content item management system and synchronizing over a data network content items stored on the content item management system's servers with content items stored at the users' personal computing devices. However, online service 132 is not limited to being a content item management system and online service 132 can provide another type of online service in addition to or instead of a content item management service such as, for example, a messaging service or a search service. More generally, online service 132 can be any type of online service where it is useful to present upsell content in addition to primary application content to users at their personal computing devices.

User premises 110 may be a physical location where a human user 124 (or just “user 124”) is located. For example, user premises 110 may be the user's 124 home, school, office, car, or other physical location where the user 124 is physically located.

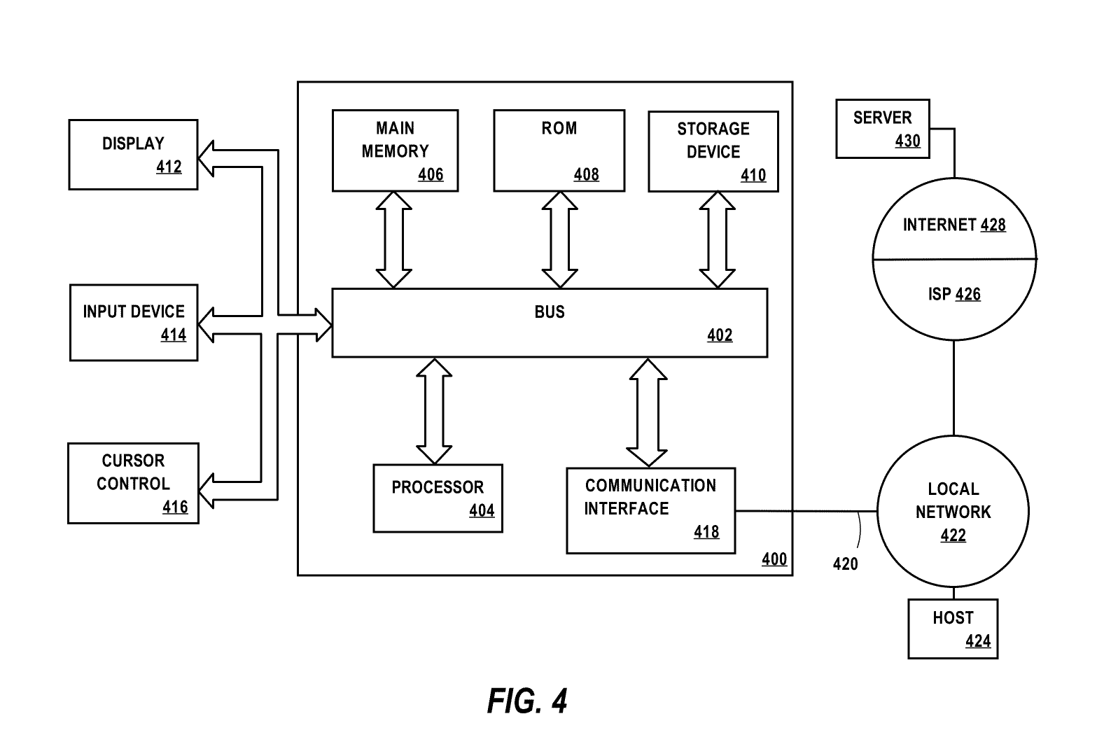

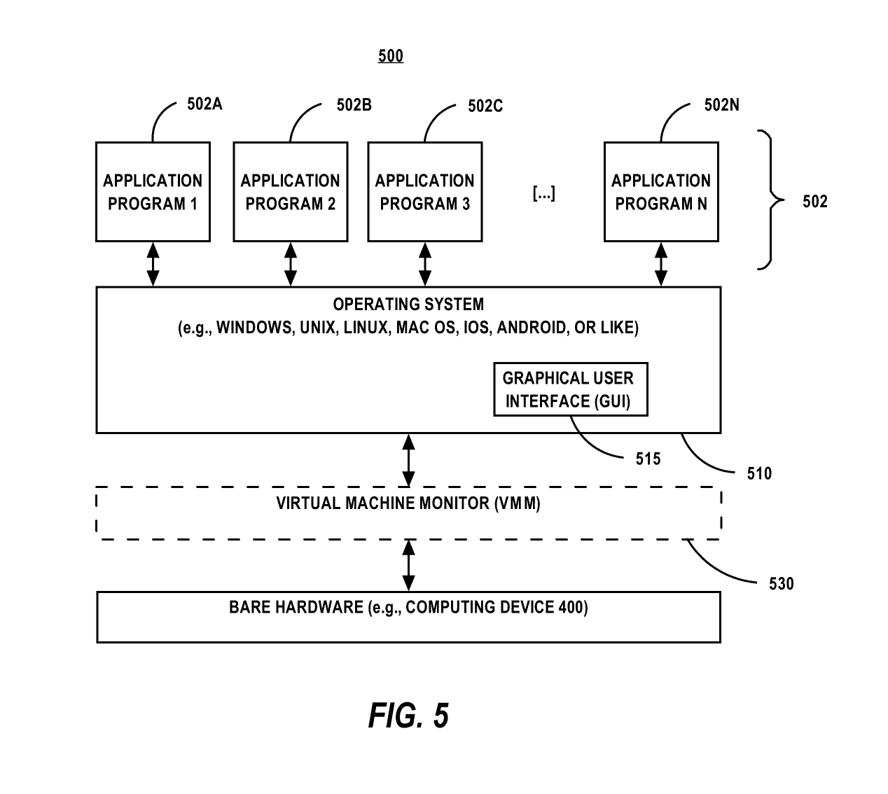

The user 124 uses a user computing device 112 (or just “user device 112”) at user premises 110. The user device 112 may be virtually any type of stationary or mobile personal computing device. For example, the user device 112 may include basic hardware computing components such as those of computing device 400 of FIG. 4 described below. The user device 112 may also include a basic software system for controlling the operation of user device 112. For example, the user device 112 may be configured with software system 500 of FIG. 5 described in greater detail below. The user device 112 has or is operatively coupled to a computer video display 116 (or just “display 116”). For example, the display 116 can be a computer video monitor, a touch screen display, or other type of electronic visual display.

While in some embodiments environment 100 includes a single user device, environment 100 includes more than one user device in other embodiments. For example, online service 132 may support hundreds, thousands, millions, even billions of users each using their respective user devices at various times to interact with online service 132 over data network 126.

A graphical user interface 118 (or just “GUI 118”) may be displayed on the display 116. The GUI 118 may be driven by a client application 114 (i.e., one or more sets of computer-executable instructions) that is configured to execute on the user device 112. In some embodiments, the client application 114 is downloaded or otherwise obtained from the online service 132 and installed or otherwise configured to execute on the user device 112. The GUI 118 may include a number of different graphical user interface elements such as, for example, windows, dialogs, panels, buttons, scrollbars, text, images, video, graphics, and the like.

In some embodiments, the GUI 118 is displayed on the display 116 within a web browser window that is also displayed on the display 116. The web browser window may be driven by a conventional web browser application (i.e., one or more sets of computer-executable instructions) that executes on the user device 112. For example, the conventional web browser application can be INTERNET EXPLORER, GOOGLE CHOME, SAFARI, FIREFOX, OPERA, and the like. In these embodiments, the instructions of the client application 114 for driving the GUI 118 may include instructions that conform to a standardized or conventional data format. For example, the client application 114 may include HyperText Markup Language (HTML), Cascading Style Sheet (CSS), JAVASCRIPT instructions, and the like.

In other embodiments, the GUI 118 is displayed on the display 116 within an operating system window that is also displayed on the display 116. The operating system window may be driven by a conventional operating system (i.e., one or more sets of computer executable instructions) that executes on the user device 112. For example, the conventional operating system can be IOS, ANDROID, WINDOWS, and the like. In these embodiments, the instructions of the client application 114 for driving the GUI 118 may include instructions compatible with a particular operating system that is configured to execute on the user device 112. For example, the client application 114 may include SWIFT and/or OBJECTIVE-C instructions on IOS-based user devices or JAVA instructions on ANDROID-based user devices.

The user 124 may interact with the GUI 118 to issue commands to the client application 114. In response to some of the commands, the client application 114 may cause a “user” request 128 to be sent from the user device 112 over the data network 126 to a web server system 134 of the online service 132. The user request 128 may be for primary application content 120 provided by the online service 132. The primary application content 120 requested may vary depending on the type of the online service 132. For example, if the online service 132 is an online electronic messaging provider, then the primary application content 120 may include a listing of messages that are in the user's 124 messaging in-box. As another example, if the online service 132 is a content item management system, then the primary application content 120 may include a listing of the user's 124 content items (e.g., documents, files, and photos) that are managed (e.g., hosted) by the content item management service. As yet another example, if the online service 132 is a search engine, then the primary application content 120 may include a listing of search results deemed relevant to the user's 124 search query. These are just some non-limiting examples of possible primary application content 120. More generally, the primary application content 120 may include any visual content (e.g., text, graphics, images, video, etc.) provided by the online service 132 that is not upsell content and which the user 124 primarily uses the online service 132 to consume.

According to some embodiments, the term “upsell content” refers to text, graphics, images, video, or some combination thereof which is presented to a user in a computer graphical user interface in conjunction with primary application content of an online service that has the goal of persuading the user to increase the user's level of engagement with the online service as opposed to merely interacting with the primary application content that is currently presented to the user. The increased level of engagement can include all of the following forms, or a subset or a superset thereof:
the user using the online service to make a more expensive purchase;
the user using the online service to purchase, subscribe, or register for an increased service level from the online service provider;
the user learning about a new feature or features of the online service and using the new feature or features;
the user using the online service to change the user's user account password used by the online service to authenticate the user for the purpose of increased security; and
the user using the online service to provide additional personal information to the online service provider such as, for example, by completing a job application for an open position with the online service provider or by completing an online survey about the online service.

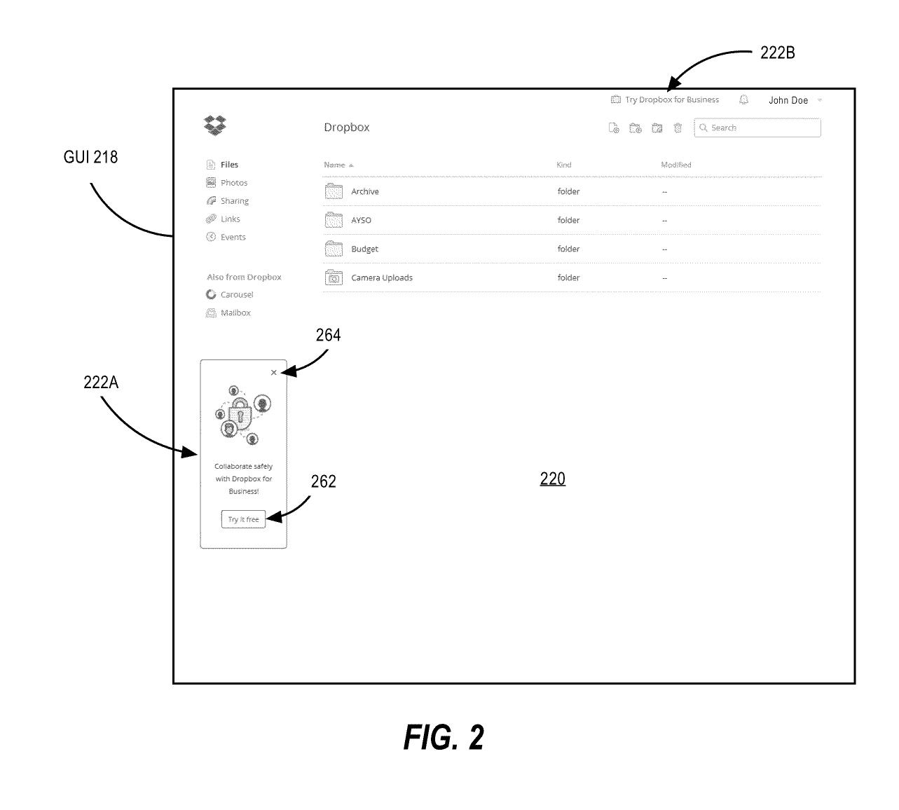

Turning briefly to FIG. 2, it depicts an example of upsell content 222A, 222B displayed in a graphical user interface 218 (or just “GUI 218”) in conjunction with primary application content 220. In this example, the GUI 218 is a web page and the upsell content 222A and 222B is displayed on the same web page as the primary application content 220. Also in this example, the online service is a content item management service in which a user named “John Doe” hosts files with the content item management service in folders named “Archive”, “AYSO”, “Budget”, and “Camera Uploads”. The primary application content 220 includes all of the GUI 218 except for the upsell content 222A and the upsell content 222B. The upsell content 222A promotes a “Dropbox for Business” product of the content item management service with the text “Collaborate safely with Dropbox for Business!” and an associated graphic depicting secure collaboration between users. Upsell content 222A also includes an actionable “Try it free” button 262 that the user can activate with user input (e.g., pointing device or touch input input) to learn more about the upsell product. For example, activating button 262 with user input may cause a web page to be displayed that allows the user begin using the “Dropbox for Business” product for a trial period. Upsell content 22A also includes an actionable dismissal button 264 that the user can activate with user input to cause the upsell content 222A to no longer be displayed in GUI 218. The upsell content 222B also promotes the “Dropbox for Business” product with the text “Try Dropbox for Business” and a graphic of a briefcase. The text of upsell content 22B is also an actionable hyperlink which the user can activate with user input to learn more about the upsell product.

Returning again to the environment 100 of FIG. 1, the data network 126 (or just “network 126”) over which the user request 128 is sent can be a conventional data network in which data is transported over the network 126 in packets. For example, the network 126 may be the Internet and the user request 128 may be transported over the Internet in one or more Internet Protocol (IP) packets. The user device 112 may connect to the network 126 using any number of a wide variety of different types of data networks. For example, the user device 112 may connect to the network 126 using a wired or wireless Local Area Network (LAN) (e.g., a wired or wireless Ethernet network), a cellular network (e.g., a Code Division Multiple Access (CDMA) network or a Global System for Mobiles (GSM) network), or the like.

The user request 128 may be formatted according to an application level networking protocol for transport over the network 126. For example, the user request 128 may be formatted in accordance with the HyperText Transfer Protocol (HTTP). The user request 128 may also be cryptographically encrypted for security. For example, the user request 128 may be a HyperText Transfer Protocol Secure (HTTPS) request cryptographically encrypted according to the Secure Sockets Layer (SSL) protocol or Transport Layer Security (TLS) protocol.

The user request 128 may include a “primary application content identifier” identifying the primary application content 120. In some embodiments, the primary application content identifier is or is a component of a Uniform Resource Locator (URL) that refers to the primary application content 120.

Generally, a URL is a character string that refers to a resource. A URL may include as components a protocol (e.g., “http” or “https”), followed by a colon character (‘:’) and two slashes (“II”), followed by a host (e.g., a domain name, a hostname, or an IP address), optionally followed by another colon and a port number, and optionally followed by a path to the resource. A URL may also include other components such as, for example, a query string and/or fragment identifier. For example, the “home” web page of a web site may be identified by the URL “https://www.somedomain.com/home”. In this example, “https” is the protocol component of the URL, “www.somedomain.com” is the host component, and “/home” is the path component. In some cases where a path is not provided as part of the URL a default path may be assumed such as, for example, “/”, “/home”, or “/default”.

In some embodiments, the primary application content identifier is the path component of a URL that refers to the primary application content 120. For example, the primary application content identifier of the “home” web page may be “/home”. However, the primary application content identifier can be an entire URL or be composed of URL components other than or in addition to the path component.

The web server system 134 (or just “web server 134”) receives the user request 128 from the user device 112 over the network 126. The user request 128 may cause the web server 134 to return a user response 130 back to the user device 112 over the network 126. The user response 130 may include just selected upsell content 122 or both the primary application content 120 and the selected upsell content 122. The upsell content 122 returned in user response 130 may be selected based on complex user archetypes as described herein.

In response to receiving the user response 130 from the web system 134, the client application 114 may display the selected upsell content 122 in the GUI 118 on the display 116 in conjunction with display of the primary application content 120. Like the user request 128, the user response 130 may be sent over the network 126 in one or more packets (e.g., IP packets) and formatted according to an application level networking protocol (e.g., HTTP) and may be also cryptographically encrypted (e.g., by SSL or TLS).

While in some embodiments the user response 130 is the first response sent by the web server 134 to the user device 112 after receiving the user request 128, the user response 130 is the second or subsequent response sent by the web server 134 to the user device 112 after receiving the user request 128. For example, after receiving the user request 128 from the user device 112, the web server 134 may send a first response to the user device 112 that includes the primary application content 120. The client application 114 processing (e.g. displaying) the primary application content 120 at the client device 112 may cause the client device 112 to send a second request to the web server 134 and the web server 134 may send the user response 130 to the user device 112 after receiving the second request. Thus, description herein referring to sending or returning a response “in response to” a request is not limited to encompassing only the first response that is sent or returned in response to receiving the request but instead encompasses any sent or returned response that is caused by the request, which may not necessarily be the first sent or returned response.

The web server 134 may be implemented by one or more server computers. For example, a server computer may include basic hardware computing components such as those of computing device 400 of FIG. 4 described below. A server computer may also include a basic software system for controlling the operation of the server computer. For example, a server computer may be configured with software system 500 of FIG. 5 described in greater detail below. The web server 134 may be connected to the network 126 via a data center or other hosting facility. The server computers of the web server 134 may also be connected to each other via a data network such as, for example, an IP-based data network.

The web server 134 executes a server application 136 (i.e., one or more sets of computer-executable instructions). The server application 136 is responsible for handling and processing the user request 128 from the user device 112 and for formulating and returning the user response 130 to the user device 112.

The online service 132 may also include an upsell campaign server system 138 (or just “campaign server 138”). The campaign server 138 may be implemented by one or more server computers. For example, a server computer may include basic hardware computing components such as those of computing device 400 of FIG. 4 described below. A server computer may also include a basic software system for controlling the operation of the server computer. For example, a server computer may be configured with software system 500 of FIG. 5 described in greater detail below. The campaign server 138 may be connected to the web server 134 by a data network such as, for example, an IP-based data network.

The campaign server 138 receives an “upsell” request 156 from the web server 134 for upsell content 122 and returns an “upsell” response 158 back to web server 134. The upsell response 158 may include upsell content 122 selected based on complex user archetypes as described herein. The web server 134 may send the upsell request 156 to the campaign server 138 in response to receiving the user request 128 from the user device 112. The user response 130 returned to the user device 112 may include the upsell content 122 returned to the web server 134 by campaign server 138 in the upsell response 158. Like the user request 128 and the user response 130, the upsell request 156 and the upsell response 158 may be sent over a data network in one or more packets (e.g., IP packets) and formatted according to an application level networking protocol (e.g., HTTP) and may be also cryptographically encrypted (e.g., by SSL or TLS).

While in some embodiments the user response 130 and the upsell response 158 includes the actual text, graphic, image, and/or video data of the selected upsell content 122, the user response 130 and the upsell response 158 include references or links to use to retrieve the actual text, graphic, image, and/or video data of the selected upsell content 112 in other embodiments. For example, user response 130 and upsell response 158 may include a URL or portion of a URL (e.g., a path) or other instructions that the client application 114 can use to download the actual text, graphic, image, or video data of the selected upsell content 112 from the online service 132. Similar embodiments are possible with respect to the primary application content 120. Thus, reference herein to a response “including” primary application content or upsell content is meant to encompass implementations where the response includes the actual text, graphic, image, and/or video data of the content and implementations where the response includes references or links to at least some of the actual text, graphic, image, and/or video data of the content. Similarly, upsell content and primary application content, when stored in a database, in a file system, or other computer storage, may be stored in a form where at least some of the actual text, graphic, image, and/or video data of the content is referred to by references or links (e.g., URLs or portions of URLs.)

The campaign server 138 executes an upsell campaign application 140 (i.e., one or more sets of computer-executable instructions). The upsell campaign application 140 (or just “campaign application 140”) is responsible for handling and processing the upsell request 156 from the web server 134, for selecting the upsell content 122 based on complex user archetypes as described herein, and for formulating and returning the upsell response 158 to the web server 134.

The user 124 may be authenticated such that the identity of the user 124 making the request 128 is known to the web server 134. For example, the user 124 may provide a valid username/password combination or other valid authentication credentials that is used to identify a user account held with the online service 132. The upsell request 156 to the campaign server 138 may include a “user identifier” of the user 124. The user identifier may be established based on the web server 134 or other user authentication system successfully authenticating the user 124.

The user identifier can be a user account identifier or other type of user identifier (e.g., the user's 124 e-mail address) that uniquely identifies the user 124 with respect to other users of the online service 132. In addition to the user identifier of the user 124, the upsell request 156 may include a primary application content identifier of the primary application content 120. With these inputs, the campaign application 140 may select, from among the available upsell content 144 stored in the campaign database system 142, particular upsell content 122 to include in the upsell response 158 returned to the web server 134 and ultimately to the user device 112 in the user response 130.

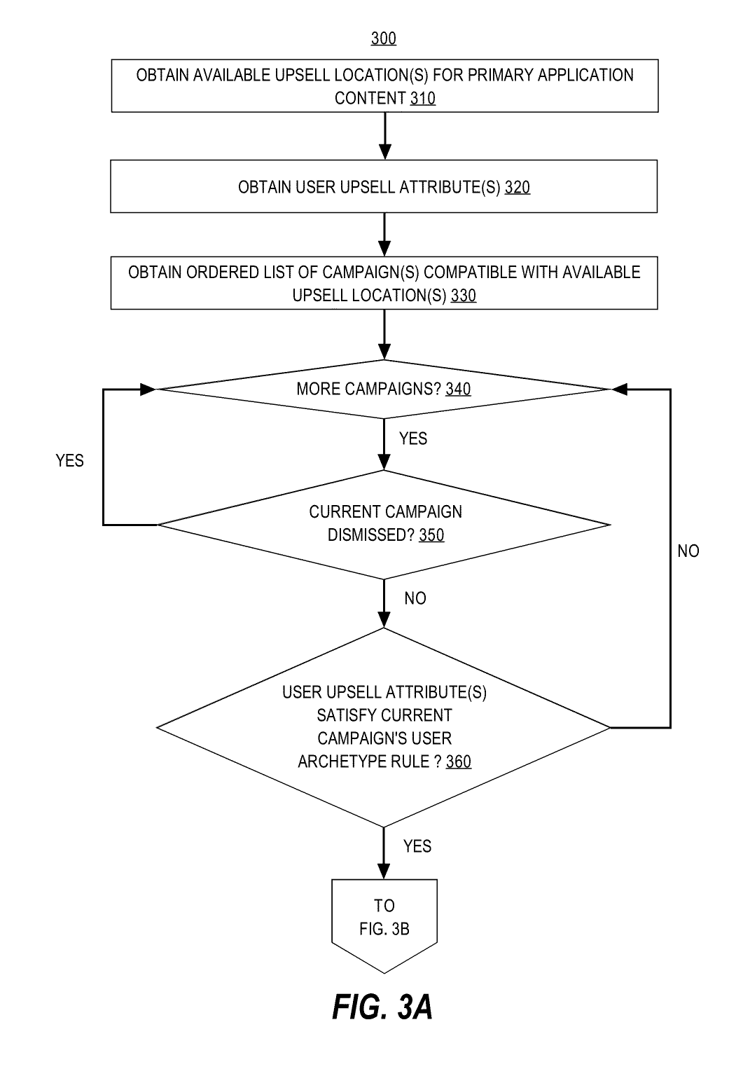

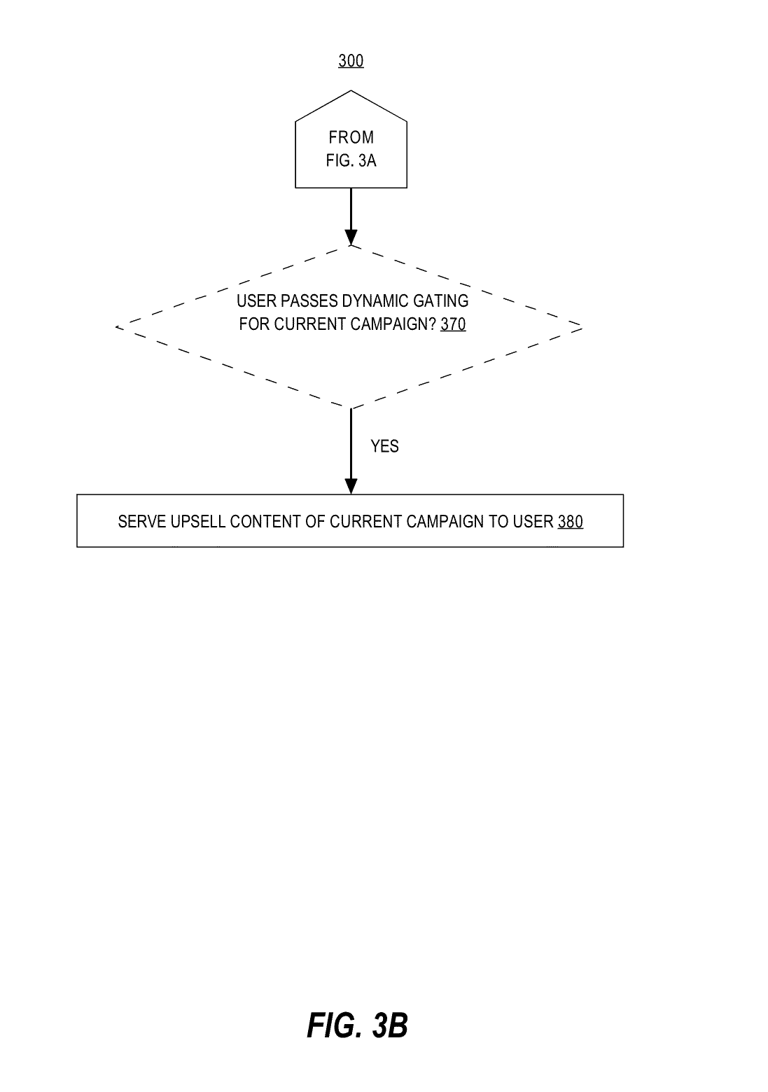

Turning now to FIG. 3A and FIG. 3B which are a flowchart of a process 300 that may be performed by, for example, the campaign application 140 to efficiently select, from among the available upsell content 144 in the campaign database, particular upsell content 122 to include in the upsell response 158 returned to the web server 134.

The process 300 begins at step 310 where the campaign application 140 obtains the available upsell content locations for the primary application content 120. As mentioned, the primary application content 120 may be identified by a primary application content identifier which may be included in the user request 128 from the user device 112 and also included in the upsell request 156 from the web server 134. At step 310, the primary application content identifier may be used to determine the available upsell content locations for the primary application content 120.

In one sense, an “available upsell content location” for primary application content refers to a location within the primary application content when displayed in a graphical user interface on a computer video display that is available for displaying upsell content. For example, the primary application content 220 of FIG. 2 has two available up sell content locations where upsell content 222A and 222B are displayed, respectively. In another sense, an “available upsell content location” for primary application content refers to a class, a group, a type, or a kind of upsell content that is compatible for display within the primary application content at the location.

According to some embodiments, a set of a plurality of predefined available upsell content locations exists for all primary application content provided by the online service 132. Each such predefined available upsell content locations may be identified by a corresponding value (e.g., a character string value, an integer value, or an enumeration value). For example, the plurality of predefined available up sell content locations may include all of the following predefined available upsell content locations, or a subset or a superset thereof:

TABLE 1

| Predefined Available Upsell | |
|---|---|
| Content Location Value | Description |
| HEADER_BUBBLE | Refers to an available upsell content |
| | location next the user's name in the top |
| | right corner of the primary application |
| | content. See, for example, upsell content |
| | 222B of FIG. 2. |
| HOME_MODAL | Refers to an available upsell content |
| | location on the home web page of the |
| | online service. See, for example, upsell |
| | content 222A of FIG. 2. |
| SHARE_HOME_MODAL | Refers to an available upsell content |
| | location within primary application |
| | content provided by a content item |
| | management service after a user uses |
| | the content item management service |
| | to share a folder with another user |
| | of the content item management server. |
| TOP_NAVBAR | Refers to an available upsell content |
| | location within a navigation bar at |
| | the top of primary application content. |

The above table provides just some examples of possible predefined available upsell content locations that may be associated with primary application content provided by the online service 132. More generally, the set of predefined available upsell content locations and the values identifying them may vary depending on a variety of different factors according to the requirements of the implementation at hand such as, for example, the type of online service, the space available within primary application content provided by the online service for other content, the display screen sizes of user computing devices that primary application content provided by the online service is displayed on, among other factors.

At step 310, to determine the available upsell content locations for the primary application content 120, a key-value mapping (e.g., an associative array, a map, a dictionary, a symbol table, etc.) may be consulted with the primary application content identifier of the primary application content 120. The mapping may include a set of key-value pairs. Each key-value pair may have, for the key, a primary application content identifier of primary application content provided by the online service 132. For example, the key can be a character string that matches a primary application content identifier of primary application content provided by the online service 132. For example, if a primary application content identifier of primary application content 120 is “/home”, then the key may be the character string “/home”. As an alternative example, the key can be a regular expression character string that a given primary application content identifier can be evaluated against using a regular expression pattern matching algorithm. For example, the key may be the regular expression character string “/home*” which would match all primary application content identifiers equaling or having the prefix “/home”. The value associated with the key in the key-value pair may be a list of one or more values, each identifying a predefined available upsell content location that is compatible with all primary application content having a primary application content identifier that matches the key. For example, assume the primary application content 220 of FIG. 2 has a primary application content identifier of “/home”. Then the key-value mapping may contain a key-value pair in which the key is “/home” and the value is the list [HEADER_BUBBLE, HOME_MODAL].

While in some embodiments the campaign application 140 consults a key-value mapping to map the primary application content identifier of the primary application content 120 to a list of one or more predefined available upsell content location values, the server application 136 performs this mapping in other embodiments. In these other embodiments, instead of sending the primary application content identifier in the upsell request 156 to the campaign server 138, the web server 134 can send the list of predefined available upsell content location values in the upsell request 156 after identifying them in the key-value mapping. Also in these other embodiments, the key-value mapping may be stored at the web server 134 instead of at the campaign server 138.

At step 320, a set of one or more user upsell attributes 148 for the user 124 is retrieved from the user upsell attribute database system 146. Each of the user upsell attributes 148 for the user 124 corresponds to one predefined complex user archetype and has a value indicating whether the user 124 is or is not the corresponding predefined complex user archetype. For example, the value can be a Boolean value in which one of the two values indicates that the user 124 is the corresponding predefined complex user archetype and the other of the two values indicates that the user 124 is not the corresponding predefined complex user archetype.

According to some embodiments, a complex user archetype is a type of user of the online service 132 that exhibits a certain pattern of usage of the online service 132 over a period of time. A set of a plurality of predefined complex user archetypes may be used. Each such predefined complex user archetype may be identified by a corresponding value (e.g., a character string value, an integer value, or an enumeration value). For example, the plurality of predefined complex user archetypes may include all of the following predefined complex user archetypes, or a subset or a superset thereof:

TABLE 2

| Predefined Complex User | |
|---|---|
| Archetype Value | Description |
| MAU | A user who used the online service in the |
| | past 28 days. |
| WAU | A user who used the online service in the |
| | past 7 days. |
| DAU | A user who used the online service in the |
| | past day. |
| MOBILE_ACTIVE | A user who used the online service from a |
| | mobile computing device (e.g., a cell |
| | phone) in the past 28 days. |
| CLIENT_ACTIVE | A user who used the online service from a |
| | desktop computing device (e.g., a laptop |
| | computer) in the past 28 days. |
| WEB_ACTIVE | A user who accessed the online service |
| | using a web browser in the past 28 days. |
| PHOTO_HEAVY_USER | A user who uploaded 10 or more digital |
| | photos to the online service or that edited 1 |
| | or more digital photos hosted with the |
| | online service in the past 28 days. |
| WORK_USER | A user who uploaded 5 or more work files |
| | to the online service or that edited 1 or more |
| | work files hosted with the online service in |
| | the past 28 days. Here, a work file may be |
| | defined or detected according to various |
| | different criteria such as, for example, by |
| | file type, file name, and/or file content. |

The above table provides just some examples of possible predefined complex user archetypes. More generally, the set of predefined complex user archetype and the values identifying them may vary depending on a variety of different factors according to the requirements of the implementation at hand such as, for example, the type of online service and the categories of users to be targeted with upsell content.

According to some embodiments, the set of user upsell attributes 148 for the user 124 is determined based on a set of user events 152 collected for the user 124 in the user event database system 150. The set of user events 152 reflect the user's 124 recent usage and interaction with primary application content and upsell content provided by the online service 132 over a period of time. In particular, each time a request is received over the data network 126 from a user device (e.g., 112) of the user 124 by the web server 134 for primary application content or upsell content, the web server 134 may record or log one or more user events reflecting processing and handling of the user's request by the web server 134. Each such recorded user event may be collected over a period of time as user events 152 in the user event database system 150. The period of time may span hours, days, weeks, or months, for example.

According to some embodiments, the set of user events 152 collected for the user 124 in the user event database system 150 indicate all of the following for a period of time, or a subset or a superset of this information:
Which features of the online service 132 the user 124 used during the period of time;
When the user 124 used the features;
The type of user devices that the user 124 accessed the features from;
For each feature usage, metadata reflecting the action performed by the user 124 when using the feature;
Which upsell content the user 124 has engaged with (e.g., by activating a “Try Now!” or other similar button to engage or interact with the upsell content); and
Which upsell content the user 124 has dismissed (e.g., by activating a dismissal button of the upsell content).

According to some embodiments, a data pipeline 154 processes the set of user events 152 collected for the user 124 to produce the set of user upsell attributes 148 for the user 124. Such processing may include processing the set of user events 152 through a series of MapReduce jobs. For example, the MapReduce jobs in some embodiments are implemented in accordance with the data processing techniques described in J. Dean and S. Ghemawat, “MapReduce: Simplified Data Processing on Large Clusters”, Google, Inc., 2004, the contents of which is hereby incorporated by reference in its entirety.

According to some embodiments, the latest set of user events 152 for the user 124 collected in the user event database system 150 is regularly processed by the data pipeline 154 to produce a latest set of user upsell attributes 148 for the user 124 to store in the user upsell attribute database system 146. For example, the data pipeline 154 may produce a new set of user upsell attributes 148 for the user 124 once a day or on some other periodic or semi-periodic interval by processing the latest set of user events 152 for the user 124 collected in the user event database system 150. In this way, the user upsell attributes 148 may reflect the user's 124 most recent interaction with the online service 132 over a period of time. For example, the user upsell attributes 148 may reflect the user's 124 interaction with the online service 132 in the past day, the past week, the past 28 days, the past month, or some other recent past period of time.

The user upsell attribute database system 148 may store sets of user upsell attributes for a large number of users of the online service 132. In some implementations, the user upsell attribute database system 146 is implemented as a large-scale distributed database system for storing sets of user upsell attributes for a large number of users such as, for example, upwards of thousands or millions of users or more. In one example implementation, the user upsell attribute database system 146 is implemented using APACHE HADOOP and APACHE HIVE open source software.

Similarly, the user event collection database system 150 may store sets of user events for a large number of users of the online service 132. In some implementations, the user event collection database system 150 is implemented as a distributed append-only commit log. In one example implementation, the user event collection database system 150 is implemented using ADAPCHE CASSANDRA open source software.

In some embodiments, processing user events 152 through the data pipeline 154 includes applying data analytic algorithms to the user events 152 to produce one or more of the user upsell attributes 148 for the user 124. A campaign may then target the user 124 based on these user upsell attributes 148 produced as a result of applying a data analytic algorithm to the user events 152. For example, a data analytic algorithm may determine that the user 124 has positively but not completely engaged with a first campaign that targets users who use the online service 132 to store their digital photos, for example, with the user archetype rule PHOTO_HEAVY_USER=TRUE, where the PHOTO_HEAVY_USER user archetype is defined, for example, as a user who uploaded 10 or more digital photos to the online service 132 or that edited 1 or more digital photos hosted with the online service 132 in the past 28 days. The upsell content of the first campaign, for example, may promote a feature of the online service 132 whereby the user 124 can pay for increased data storage capacity for hosting more of the user's 124 digital photos with the online service 132. The user's 124 positive but not complete engagement with the first campaign may be identified based on detecting a user event 152 or events 152 that indicate the user 124 positively interacted with the upsell content of the first campaign (e.g., by activating a “Try Now” button or the like of the upsell content) but did not actually enroll or pay for the higher service level promoted by the first campaign. In this case, a user upsell attribute 148 may be produced for the user 124 such as, for example, INCHOATE_PHOTO_UPSELL_USER=TRUE, that reflects that the user 124 positively interacted with upsell content of the first campaign but did not actually enroll or pay for the higher service level promoted by the first campaign. A second campaign may then be created, and/or the first campaign modified, to target users such as user 124 with a user archetype rule that incorporates the Boolean expression INCHOATE_PHOTO_UPSELL_USER=TRUE. In addition or alternatively, the user archetype rule of an existing campaign may be modified to incorporate an additional Boolean expression so as to refine or focus the set of users that are targeted by the campaign or another campaign that uses the modified user archetype rule. For example, the user archetype rule of the first campaign may be modified to be the Boolean expression (PHOTO_HEAVY_USER=TRUE) AND (INCHOATE_PHOTO_UPSELL_USER=TRUE) to target heavy photo users as defined above and who also positively interacted with the upsell content of the first campaign but did not yet enroll or pay for the higher service level promoted by the first campaign.

At step 330, a list of one or more campaigns that are compatible with the available upsell locations of the primary application content 120 as determined at step 310 is obtained from the campaign database system 142. Campaigns in this list also referred to herein as “candidate campaigns”. Very generally, a campaign is a set of users to target with specific upsell content. For example, a campaign may wish to target photo heavy users (e.g., users who uploaded 10 or more digital photos to the online service or that edited 1 or more digital photos hosted with the online service in the past 28 days) with upsell content that promotes a photo management feature of the online service. As another example, another campaign may wish to target work users (e.g., users who upload 50 or more work files to the online service or that edited 1 or more work files hosted with the online service in the past 28 days) with upsell content that promotes a business directed feature of the online service. Campaigns may be stored in the campaign database system 142 as one or more database records (e.g., rows). A campaign may be associated in the campaign database system 142 with a list of one or more available upsell location values specifying the one or more available upsell locations the upsell content of the campaign is compatible with. At step 330, the list of candidate campaigns may be obtained by querying the campaign database system 142 for campaigns stored in the campaign database system 142 associated with an available upsell location value that matches one of the available upsell location values corresponding to an available upsell location of the primary application content 120 as determined at step 310.

The set of users to target by a campaign is represented by a “user archetype rule”. The user archetype rule may be associated with the campaign in the campaign database system 142. The user archetype rule may be an expression composed of user upsell attributes that defines the set of users targeted by the campaign. More specifically, the expression may be a Boolean expression which, when evaluated against a given set of user upsell attributes for a user, evaluates to TRUE or FALSE. If the Boolean expression evaluates to TRUE when evaluated against the given set of user upsell attributes, then the user is in the set of users targeted by the campaign. If the Boolean expression evaluates to FALSE, then the user is not in the set of users targeted by the campaign. For example, a user archetype rule may target all work users (e.g., users who upload 5 or more work files to the online service or that edited 1 or more work files hosted with the online service in the past 28 days) with the Boolean expression WORK_USER=TRUE. As a more complex example, a user archetype rule may target all photo heavy users who also actively use their mobile computing devices to interact with the online service 132 with the Boolean expression (PHOTO_HEAVY_USER=TRUE) AND (MOBILE_ACTIVE=TRUE). These are just two examples of possible user archetype rules and different rules are possible according to the particular user upsell attributes that are stored in the user upsell attribute database system 146 and the requirements of the particular implementation at hand.

The list of candidate campaigns may be grouped into one or more predefined priority groups. Each such priority group may correspond to a type of campaign. For example, one priority group may include campaigns directed to promoting a class or group of related features provided by the online service 132. Another priority group may include campaigns directed to provide useful or helpful tips on how best to use features of the online service 132. By grouping campaigns into priority groups, operations may be performed on campaigns as a group. For example, in some embodiments described in greater detail below, candidate campaigns are evaluated for potentially serving to the user 124 in priority group order. That is, all candidate campaigns in higher-priority priority groups are evaluated before any candidate campaigns in lower-priority priority groups. As another example, according to some embodiments, candidate campaigns in a priority group for which the user 124 recently dismissed (e.g., in the past 90 days) a campaign in that priority group are not evaluated for potentially serving to the user 124. Within a priority group, candidate campaigns may also be ranked (ordered) by priority. When evaluating candidate campaigns within a priority group for potentially serving to the user 124, the candidate campaigns may be evaluated in priority order.

Steps 340, 350, 360, and 370 may be repeated until it is determined that the user's 124 upsell attributes 148 satisfy a user archetype rule of a campaign in the list of candidate campaigns or until all candidate campaigns have been considered. Candidate campaigns may be considered in priority order starting with the highest priority candidate campaign in the highest-priority priority group and proceeding to the lowest priority candidate campaign in the lowest-priority priority group considering each candidate campaign until one if found that has a user archetype rule that is satisfied by the user's 124 upsell attributes 148 obtained at step 320. The candidate campaign currently under consideration is referred to herein as the “current campaign.”

At step 340, if there is no current campaign, then the process 300 ends. However, if there is a current campaign, then the process proceeds to step 350.

At step 350, a determination is made whether to skip the current campaign because it belongs to a priority group that the user 124 has recently dismissed. Specifically, if the user 124 has recently dismissed a campaign that belongs to the priority group to which the current campaign belongs, then the current campaign may be removed from consideration for serving upsell content to the user 124. By doing this, the process 300 avoids serving upsell content the user 124 is more likely to dismiss. The period of time that is considered recently dismissed may vary according to the requirements of the particular implementation at hand. For example, a priority group may be considered dismissed if the user 124 has dismissed a campaign belonging to the priority group in the past 90 days or some other past period of time. A campaign may be considered dismissed if the user 124 has activated a dismissal button (e.g. button 264 of FIG. 2) of the upsell content associated with campaign. Dismissal of a campaign by the user 124 may be detected by processing user events 152 through data pipeline 154. For example, one or more of the user events 152 may reflect that the user 124 activated a dismissal button of upsell content associated with a campaign. Campaigns (and/or priority groups) recently dismissed by the user 124 may be stored in the user upsell attributes database system 146 for retrieval during step 320 of process 300.

If, at step 350, it is determined to skip the current campaign, then process 300 returns to step 340 to consider the next campaign in priority order. Note that the next campaign in priority order can be the highest priority campaign in the next highest priority group because it has been determined that the current priority group containing the current campaign should be dismissed.

At step 360, if the current campaign is not dismissed at step 350, then it is determined whether the user's 124 upsell attributes 148 satisfy the user archetype rule of the current campaign. This determination is made by evaluating the user archetype rule against the user's 124 upsell attributes 148. For example, if the user archetype rule for the current campaign is (PHOTO_HEAVY_USER=TRUE) AND (MOBILE_ACTIVE=TRUE), then the user archetype rule is satisfied if the user's 124 upsell attributes 148 include PHOTO_HEAVY_USER and MOBILE_ACTIVE both set to the value TRUE. Since the user archetype rule is an expression composed of user upsell attributes, evaluation of the rule in terms of the user's 124 upsell attributes 148 is computationally efficient.

If, at step 360, it is determined that the user's 124 upsell attributes 148 satisfy the user archetype rule of the current campaign, then, at step 380, the upsell content 122 of the current campaign may be included in the upsell response 158 returned to the web server 134, and ultimately in the response 130 returned to the user device 112.

On the other hand, if it is determined that the user's 124 upsell attributes 148 do not satisfy the user archetype rule of the current campaign, then the process 300 proceeds back to step 340 to consider the next campaign in priority order. The next campaign in priority order is either the next highest priority campaign in the current priority group or, if all campaigns in the current priority group have been considered, the highest priority campaign in the next highest priority group.

According to some embodiments, if, at step 360, it is determined that the user's 124 upsell attributes 148 satisfy the user archetype rule of the current campaign, then, at optional step 370, the web server 134 performs a dynamic gating check to determine if the selected upsell content 122 should be served to the user 124. If the dynamic gating check passes, the web server 134 includes the selected upsell content 122 in the response 130 returned to the user device 112 at step 380. If the dynamic gating check does not pass, the web server 134 does not include the selected upsell content 122 in the response 130 and the process 300 may proceed back to step 340 to consider the next campaign in priority order or the process may end.

The dynamic gating check may be performed at step 370 because the user's 124 upsell attributes 148 may not reflect the user's 124 most recent interaction with the online service 132. For example, the user's 124 upsell attributes 148 may be updated in the user upsell attribute database system 146 every few hours or on some other interval depending on how quickly the user's 124 most recent user events 152 can be processed by the data pipeline 154. In this case, if may not be appropriate to serve the upsell content 122 of the current campaign to the user 124 based on the user's 124 upsell attributes 148 even if it was determined at step 360 that the user's 124 upsell attributes 148 satisfy the user archetype rule of the current campaign. For example, the upsell content 122 may promote a feature of the online service 132 that the user 124 enrolled in or purchased since the user's 124 upsell attributes 148 were last updated in the user upsell attribute database system 146. In this case, serving the upsell content 122 to the user 124 might astonish or confuse the user 124.

According to some embodiments, the dynamic gating check at step 370 generally involves querying one or more database systems which are updated with “near real-time” information about the user's 124 interaction and online service 132 behavior more frequently that the user's 124 upsell attributes 148 are updated in the user upsell attribute database system 146. The near real-time information may reflect the user's 124 most recent interaction and online service 132 behavior. The near real-time information may be produced by the data pipeline system 154 based on processing recent user events 152. However, to facilitate more frequent updating of the near real-time information about the user 124, the near real-time information may be limited to certain information about the user 124 needed to perform the dynamic gating check at step 370. For example, the near real-time information may include information about type of computing device the user 124 most recently used to interact with the online service 132 and/or information about what features or products the user 124 recently enrolled in or purchased from the online service 132 provider. More generally, the near real-time information may include any information about the user 124 useful for determining whether the upsell content 122 should still be served to the user 124. Such information may be based on a variety of factors according to the requirements of the particular implementation at hand including, but not limited to, how frequently the user's 124 upsell attributes 148 are updated in the user upsell attribute database system 146, how frequently the near real-time information for the user 124 can be produced by the data pipeline 154, and the type of campaigns and associated upsell content that are available for serving to users.

According to some embodiments, the upsell content 122 served to the user 124 at step 380 is associated with a campaign that is also associated with a monetary discount or other monetary or non-monetary incentive for the user 124 to positively interact with the online service 132 in the manner intended by the campaign. Such positive interaction may take a variety of different forms such as, for example, the user 124 activating a “Try Now”, “Learn More”, or “Buy Now” button of the upsell content 122 and then purchasing a product or enhanced service level from the online service 132 provider or otherwise engaging with the online service 132 in the manner intended by the campaign. Upon detecting such positive interaction with the online service 132, the user 124 may receive the incentive associated with the campaign.

While an order for steps of process 300 may be implied by the description above and the flowchart of FIG. 3, steps of process 300 may be performed in a different order than the order implied. For example, step 330 may be performed before step 320. Further, some steps of process 300 may be performed concurrently with one another. For example, steps 320 and 330 may be performed concurrently or in parallel.

FIG. 4 is a block diagram that illustrates an example computing device 400 suitable for implementing some embodiments of the present invention.

Computing device 400 may take various different forms including, but not limited to, a client computer, a server computer, a network device, a mobile computing device, a cell phone, a smart phone, a tablet computer, a laptop computer, a desktop computer, a workstation computer, a personal digital assistant, a blade server, a mainframe computer, a set-top device, a gaming console, an in-vehicle computer, or other type of computing device.

Computing device 400 and its components, including their connections, relationships, and functions, is meant to be exemplary only, and not meant to limit implementations embodiments of the present invention. Other computing devices suitable for implementing embodiments of the present invention may have different components, including components with different connections, relationships, and functions.

Computing device 400 may include a bus 402 or other communication mechanism for addressing main memory 406 and for transferring data between and among the various components of device 400.

Computing device 400 may also include one or more hardware processors 404 coupled with bus 402 for processing information. A hardware processor 404 may be a general purpose microprocessor, a system on a chip (SoC), or other processor suitable for implementing the described technologies.

Main memory 406, such as a random access memory (RAM) or other dynamic storage device, also may be coupled to bus 402 for storing information and instructions to be executed by processor(s) 404. Main memory 406 also may be used for storing temporary variables or other intermediate information during execution of instructions to be executed by processor(s) 404. Such instructions, when stored in non-transitory storage media accessible to processor(s) 404, render computing device 400 into a special-purpose computing device that is customized to perform the operations specified in the instructions.

Computing device 400 also may include read only memory (ROM) 408 or other static storage device coupled to bus 402 for storing static information and instructions for processor(s) 404.

One or more mass storage devices 410 may be coupled to bus 402 for persistently storing information and instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 410 (e.g., the main hard disk for the device) stores a body of program and data for directing operation of the computing device, including an operating system, user application programs, driver and other support files, as well as other data files of all sorts.

Computing device 400 may be coupled via bus 402 to display 412, such as a liquid crystal display (LCD) or other electronic visual display, for displaying information to a computer user. In some configurations, a touch sensitive surface may be overlaid on display 412 to form a touch sensitive display for communicating touch gesture (e.g., finger or stylus) input to processor(s) 404.

An input device 414, including alphanumeric and other keys, may be coupled to bus 402 for communicating information and command selections to processor 404. In addition to or instead of alphanumeric and other keys, input device 414 may include one or more physical buttons or switches such as, for example, a power (on/off) button, a “home” button, volume control buttons, or the like.

Another type of user input device may be a cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

While in some configurations, such as the configuration depicted in FIG. 4, one or more of display 412, input device 414, and cursor control 416 are external components (i.e., peripheral devices) of computing device 400, one or more of display 412, input device 414, and cursor control 416 are integrated as part of the form factor of computing device 400 in other configurations.

Computing device 400 may implement the process steps described herein using customized hard-wired logic, one or more application-specific integrated circuits (ASICs), one or more field-programmable gate arrays (FPGAs), firmware, or program logic which, in combination with the computing device, causes or programs computing device 400 to be a special-purpose machine.

The process steps disclosed herein may also be performed by computing device 400 in response to processor(s) 404 executing one or more sequences of one or more instructions contained in main memory 406. Such instructions may be read into main memory 406 from another storage medium, such as storage device(s) 410. Execution of the sequences of instructions contained in main memory 406 causes processor(s) 404 to perform the process steps described herein. In some embodiments of the present invention, hard-wired circuitry may be used in place of or in combination with software instructions.

The term “storage media” as used herein refers to any non-transitory media that store data and/or instructions that cause a computing device to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor(s) 404 for execution. For example, the instructions may initially be carried on a magnetic disk or solid-state drive of a remote computer. The remote computer can load the instructions into its dynamic memory and send the instructions over a telephone line using a modem. A modem local to computing device 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor(s) 404 retrieves and executes the instructions. The instructions received by main memory 406 may optionally be stored on storage device(s) 410 either before or after execution by processor(s) 404.

Computing device 400 also may include one or more communication interface(s) 418 coupled to bus 402. A communication interface 418 provides a two-way data communication coupling to a wired or wireless network link 420 that is connected to a local network 422 (e.g., Ethernet network, Wireless Local Area Network, cellular phone network, Bluetooth wireless network, or the like). Communication interface 418 sends and receives electrical, electromagnetic, or optical signals that carry digital data streams representing various types of information. For example, communication interface 418 may be a wired network interface card, a wireless network interface card with an integrated radio antenna, or a modem (e.g., ISDN, DSL, or cable modem).

Network link(s) 420 typically provide data communication through one or more networks to other data devices. For example, a network link 420 may provide a connection through a local network 422 to a host computer 424 or to data equipment operated by an Internet Service Provider (ISP) 426. ISP 426 in turn provides data communication services through the world wide packet data communication network now commonly referred to as the “Internet” 428. Local network(s) 422 and Internet 428 use electrical, electromagnetic or optical signals that carry digital data streams. The signals through the various networks and the signals on network link(s) 420 and through communication interface(s) 418, which carry the digital data to and from computing device 400, are example forms of transmission media.

Computing device 400 can send messages and receive data, including program code, through the network(s), network link(s) 420 and communication interface(s) 418. In the Internet example, a server 430 might transmit a requested code for an application program through Internet 428, ISP 426, local network(s) 422 and communication interface(s) 418.

The received code may be executed by processor 404 as it is received, and/or stored in storage device 410, or other non-volatile storage for later execution.

FIG. 5 is a block diagram of a software system 500 that may be employed for controlling the operation of the example computing device 400 of FIG. 4 according to some embodiments of the present invention. As shown, a computer software system 500 is provided for directing the operation of the computing device 400. Software system 500, which may be stored in system memory (RAM) 406 and on fixed storage (e.g., hard disk) 410, includes a kernel or operating system (OS) 510. The OS 510 manages low-level aspects of computer operation, including managing execution of processes, memory allocation, file input and output (I/O), and device I/O. One or more application programs, such as client application software or “programs” 502 (e.g., 502A, 502B, 502C . . . 502N) may be “loaded” (i.e., transferred from fixed storage 410 into memory 406) for execution by the system 500. The applications or other software intended for use on the device 400 may also be stored as a set of downloadable computer-executable instructions, for example, for downloading and installation from an Internet location (e.g., Web server).

Software system 500 may include a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or client application module(s) 502. The GUI 515 also serves to display the results of operation from the OS 510 and application(s) 502, whereupon the user may supply additional inputs or terminate the session (e.g., log off).

The OS 510 can execute directly on the bare hardware (e.g., processor(s) 404) 520 of device 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the device 400.

VMM 530 instantiates and runs virtual machine instances (“guest machines”). Each guest machine comprises a “guest” operating system, such as OS 510, and one or more applications, such as applications 502, designed to execute on the guest operating system. The VMM 530 presents the guest operating systems with a virtual operating platform and manages the execution of the guest operating systems. In some instances, the VMM 530 may allow a guest operating system to run as through it is running on the bare hardware 520 of the device 400 directly. In these instances, the same version of the guest operating system configured to execute on the bare hardware 404 directly may also be able to execute on VMM 530 without modification or reconfiguration. In other words, VMM 530 may provide full hardware and CPU virtualization to a guest operating system in some instances. In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

The above-described computer hardware and software is presented for purpose of illustrating the basic underlying computer components that may be employed for implementing some embodiments of the present invention. Embodiments of the present invention, however, are not necessarily limited to any particular computing environment or computing device configuration. Instead, the embodiments may be implemented in any type of system architecture or processing environment capable of supporting the embodiments as presented in detail above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method for efficiently serving upsell content to a user of an online service based on complex user archetypes, the online service comprising one or more server computers with memory and one or more processors, the method comprising:
based on user events reflecting a user's interaction with primary application content of the online service over a period of time, for each of a plurality of predefined complex user archetypes, determining, by at least one of the processors, whether a user is or is not the predefined complex user archetype;
based on the determining, storing, by at least one of the processors, a set of a plurality of user upsell attributes for the user in a database, each of the plurality of user upsell attributes corresponding to one of the plurality of predefined complex user archetypes and having a value that indicates whether the user is or is not the corresponding predefined complex user archetype;
in response to receiving a request from a computing device used by the user:
identifying, by at least one of the processors, a plurality of upsell campaigns associated with particular primary application content of the online service, each of the plurality of upsell campaigns associated with upsell content and associated with a user archetype rule;
determining, by at least one of the processors, whether the user archetype rule associated with an upsell campaign of the plurality of upsell campaigns is satisfied by the set of user upsell attributes for the user; and
serving, by at least one of the processors, the upsell content associated with the upsell campaign to the computing device used by the user, if the user archetype rule is satisfied by the set of user upsell attributes.

2. The method of claim 1, further comprising:
collecting, by at least one of the processors, the user events reflecting the user's interaction with primary application content of the online service over the period of time;
processing, by at least one of the processors, the user events through a data pipeline to produce the plurality of user upsell attributes; and
storing, by at least one of the processors, the plurality of upsell attributes in the database.

3. The method of claim 1, wherein processing, by at least one of the processors, the user events through the data pipeline to produce the plurality of user upsell attributes comprises processing, by at least one of the processors, the user events through a series of a plurality of MapReduce phases.

4. The method of claim 1, further comprising:
evaluating, by at least one of the processors, the user archetype rule against the set of user upsell attributes;
obtaining, by at least one of the processors, a result of the evaluating; and
serving, by at least one of the processors, the upsell content associated with the upsell campaign to the computing device used by user, if the result of the evaluating is TRUE;

5. The method of claim 1, further comprising:
determining, by at least one of the processors, that at least one of the upsell campaigns belongs to a group of upsell campaigns having, as a member of the group, an upsell campaign that was previously dismissed by the user; and
wherein the upsell campaign associated with the upsell content served to the computing device used by the user does not belong to the group of upsell campaigns.

6. The method of claim 1, wherein the request is for the particular primary application content.

7. The method of claim 1, wherein the period of time is at least one day.

8. The method of claim 1, wherein each of the plurality of user upsell attributes has a Boolean value that specifies whether the user is or is not the predefined complex user archetype corresponding to the each user upsell attribute.

9. The method of claim 1, wherein determining, by at least one of the processors, whether the user archetype rule is satisfied by the set of user upsell attributes for the user comprises evaluating, by at least one of the processors, a Boolean expression against the set of user upsell attributes for the user.

10. The method of claim 1, further comprising
if the user archetype rule is satisfied by the set of user upsell attributes, querying, by at least one of the processors, a database to determine if the user passes a gating condition on serving the upsell content to the user; and
serving, by at least one of the processors, the upsell content associated with the upsell campaign to the computing device used by user, if the user passes the gating condition.

11. The method of claim 1, further comprising:
wherein the upsell campaign is associated with a monetary or non-monetary incentive for the user to interact with the online service in a manner intended by the upsell campaign; and
causing, by at least one of the processors, the user to receive the incentive in response to detecting the user interacting with the online service in the manner intended by the upsell campaign.

12. A method for efficiently serving upsell content to a user of an online service based on complex user archetypes, the online service comprising one or more server computers with memory and one or more processors, the method comprising:
based on user events reflecting a user's interaction with upsell content of the online service over a period of time, determining, by at least one of the processors, whether a user is or is not a predefined complex user archetype;
based on the determining, storing, by at least one of the processors, a user upsell attribute for the user in a database, the user upsell attribute corresponding to the predefined complex user archetype and having a value that indicates whether the user is or is not the predefined complex user archetype;
determining, by at least one of the processors, whether a user archetype rule associated with an upsell campaign is satisfied by the user upsell attribute for the user; and
serving, by at least one of the processors, upsell content associated with the upsell campaign to the computing device used by user, if the user archetype rule is satisfied by the set of user upsell attributes.

13. A computer system for efficiently serving upsell content to a user, the system comprising one or more computing devices with memory and one or more processors configured for:
based on user events reflecting a user's interaction with primary application content of the online service over a period of time, for each of a plurality of predefined complex user archetypes, determining whether a user is or is not the predefined complex user archetype;
based on the determining, storing a set of a plurality of user upsell attributes for the user in a database, each of the plurality of user upsell attributes corresponding to one of the plurality of predefined complex user archetypes and having a value that indicates whether the user is or is not the corresponding predefined complex user archetype;
in response to receiving a request from a computing device used by the user:
identifying a plurality of upsell campaigns associated with particular primary application content of the online service, each of the plurality of upsell campaigns associated with upsell content and associated with a user archetype rule;
determining whether the user archetype rule associated with an upsell campaign of the plurality of upsell campaigns is satisfied by the set of user upsell attributes for the user; and
serving the upsell content associated with the upsell campaign to the computing device used by the user, if the user archetype rule is satisfied by the set of user upsell attributes.

14. The system of claim 13, the one or more processors further configured for:
collecting the user events reflecting the user's interaction with primary application content of the online service over the period of time;
processing the user events through a data pipeline to produce the plurality of user upsell attributes; and
storing the plurality of upsell attributes in the database.

15. The system of claim 13, wherein processing the user events through the data pipeline to produce the plurality of user upsell attributes comprises processing, by at least one of the processors, the user events through a series of a plurality of MapReduce phases.

16. The system of claim 13, the one or more processors further configured for:
evaluating the user archetype rule against the set of user upsell attributes;
obtaining a result of the evaluating; and
serving the upsell content associated with the upsell campaign to the computing device used by user, if the result of the evaluating is TRUE;

17. The system of claim 13, the one or more processors further configured for:
determining that at least one of the upsell campaigns belongs to a group of upsell campaigns having, as a member of the group, an upsell campaign that was previously dismissed by the user; and
wherein the upsell campaign associated with the upsell content served to the computing device used by the user does not belong to the group of upsell campaigns.

18. The system of claim 13, wherein the request is for the particular primary application content.

19. The system of claim 13, wherein the period of time is at least one day.

20. The system of claim 13, wherein each of the plurality of user upsell attributes has a Boolean value that specifies whether the user is or is not the predefined complex user archetype corresponding to the each user upsell attribute.

21. The system of claim 13, wherein determining whether the user archetype rule is satisfied by the set of user upsell attributes for the user comprises evaluating a Boolean expression against the set of user upsell attributes for the user.

22. The system of claim 13, the one or more processors further configured for:
if the user archetype rule is satisfied by the set of user upsell attributes, querying a database to determine if the user passes a gating condition on serving the upsell content to the user; and
serving the upsell content associated with the upsell campaign to the computing device used by user, if the user passes the gating condition.

23. The system of claim 13, wherein the upsell campaign is associated with a monetary or non-monetary incentive for the user to interact with the online service in a manner intended by the upsell campaign; and wherein the one or more processors are further configured for causing the user to receive the incentive in response to detecting the user interacting with the online service in the manner intended by the upsell campaign.

24. A computer system for efficiently serving upsell content to a user, the system comprising one or more computing devices with memory and one or more processors configured for:
based on user events reflecting a user's interaction with upsell content of the online service over a period of time, determining whether a user is or is not a predefined complex user archetype;
based on the determining, storing a user upsell attribute for the user in a database, the user upsell attribute corresponding to the predefined complex user archetype and having a value that indicates whether the user is or is not the predefined complex user archetype;
determining whether a user archetype rule associated with an upsell campaign is satisfied by the user upsell attribute for the user; and
serving upsell content associated with the upsell campaign to the computing device used by user, if the user archetype rule is satisfied by the set of user upsell attributes.
